(19) United States
(12) Patent Application Publication
(10) Pub. No.: US 2012/0115719 A1
(43) Pub. Date: May 10, 2012

(54) POLYMER COMPOSITE MATERIALS

(75) Inventors: Matthew Richard Turner, Loughborough (GB); David Anthony Johnson, Loughborough (GB)

(73) Assignee: EPL Composite Solutions Ltd., Loughborough (GB)

(21) Appl. No.: 13/265,481

(22) PCT Filed: Apr. 20, 2010
(86) PCT No.: PCT/GB2010/000785

§ 371 Date: Jan. 13, 2012

(30) Foreign Application Priority Data
Apr. 21, 2009 (GB) 0906791.9

(51) Int. Cl. B41M 5/327; B32B 5/16; B32B 37/14; B41M 5/333; B41M 5/337; G01N 37/00; B41M 5/323

(52) U.S. Cl. 503/216; 73/865.8; 428/323; 428/327; 503/200; 503/221; 503/223; 503/225; 442/417; 156/60

(57) ABSTRACT

A polymer composite material (10, 110, 210, 310) is described. The material includes a settable matrix material (12), a plurality of reinforcement members (14) and a plurality of capsule members (16). Each capsule member (16) includes a shell layer (22) encapsulating an indicator material (24). The polymer composite material comprises an initial condition in which each shell layer contains the indicator material, and a damaged condition in which at least one shell layer is ruptured, releasing indicator material. The polymer composite material is changed from the initial condition to the damaged condition by the application of a predetermined force to the polymer composite material.

The present invention relates to polymer composite materials.

It is known to provide polymer composite materials which are formed of reinforcing members embedded in a thermoplastic or thermoset polymer matrix. Such materials are widely used because they offer low weight and high specific strength/stiffness coupled with excellent durability. However, it can be difficult to detect when damage has been sustained by a polymer composite material, as such damage may be difficult to detect visually. This issue becomes particularly important in safety critical applications, such as when polymer composite materials are being used in the manufacture of, for example, aircraft components. In such circumstances, relatively sophisticated inspection techniques have to be used to ensure the integrity of the polymer composite materials.

In this specification, the term “settable” is used in respect of a material which in one condition is fluid but subsequently, during or after processing, becomes substantially solid or rigid.

According to one aspect of the present invention, there is provided a polymer composite material, the material including a settable matrix material, a plurality of reinforcement members and a plurality of capsule members, each capsule member including a shell layer encapsulating an indicator material, the polymer composite material being arrangeable in a first initial condition in which each shell layer contains the indicator material, and a second damaged condition in which at least one shell layer is ruptured, releasing indicator material, the polymer composite material being moved from the first condition to the second condition by the application of a predetermined force to the polymer composite material, the release of the indicator material being arranged to indicate to a user that a predetermined force has been applied to the polymer composite material.

Possibly, the polymer composite material includes a gelcoat layer, which may form a surface layer, and may form a surface layer over the matrix material. Possibly, the gelcoat layer includes a plurality of capsule members. Possibly the matrix material includes a plurality of capsule members. Possibly the concentration (number per unit volume) of capsule members is greater in the gelcoat layer than in the matrix material. Possibly substantially all of the capsule members are located within the gelcoat layer. The addition rate of capsule members to the gelcoat layer may be between 0.05% and 20% w/w.

The matrix material may be a polymer material, and may be a thermoplastic or thermoset polymer. The polymer material may be a resin material, and may be a polyester resin, a vinylester resin, a bismaleimide resin, a polyimide resin, a cyanate ester, an epoxy resin, a phenolic resin or a polyurethane resin. The reinforcement members may be in the form of fibres, and may be formed of glass, carbon, aramid, basalt, boron or combinations thereof.

Possibly, the polymer composite material includes a structure. Possibly, each capsule member is applied to or carried by the structure. Possibly, the structure is located adjacent to the gelcoat layer. Possibly, the structure is in the form of a veil, and may be formed of polyester.

Possibly, each capsule member is a microcapsule, and may have a maximum dimension of 1 mm or less, and more possibly may have a maximum dimension of 300 microns or less.

Possibly, the shell layer is formed of one or more materials selected from the group consisting of gelatine, gum arabic, aminoplast, urea formaldehyde, melamine formaldehyde, protein, amine, alcohol, polyester, polyureaand polyurethane. Possibly, the shell layer is formed through interfacial polymerisation of a plurality of reactants in a polycondensation, and may be formed through core-shell encapsulation, microgranulation or spray drying.

In one embodiment, the indicator material is possibly a dye, which may be coloured to be visible or become visible in the second condition against the colour of other components of the polymer composite material. Possibly the dye becomes visible or more visible in ultraviolet light. The indicator material may include a carrier material, which may be a material selected from one or more materials in the group consisting of organic solvent, limonene, aromatic hydrocarbon, alcohol, naphthalene, orange oil penetrant, mineral oil and an ester. The ester may be dibutyl phthalate and/or dibutyl sebacate.

Possibly, the shell layer is substantially opaque. Possibly, the gelcoat layer permits light transmission, or the gelcoat layer may be substantially opaque.

Alternatively, the shell layer may permit light transmission, and the gelcoat layer may be substantially opaque.

In another embodiment, the indicator material possibly includes a colour former. The colour former may be one or more materials selected from the group consisting of an aminofluoran, a pyridylazonapthol, a diaminofluoran, a bisaryl carbazolylmethane, a bisindoly phthalide. Possibly, the polymer composite material includes a reagent, which in the second condition reacts with the colour former to form a reaction product which is visible or can become visible against the colour of other components of the polymer composite material. Possibly, the reagent is a material selected from the group consisting of zinc salicylate, zinc neodecanoate, clay, phenolic resin.

Possibly, the shell layer and the gelcoat layer permit light transmission.

According to a second aspect of the present invention, there is provided a product formed from a polymer composite material, the material including a settable matrix material, a plurality of reinforcement members and a plurality of capsule members, each capsule member including a shell layer encapsulating an indicator material, the polymer composite material being arrangeable in a first initial condition in which each shell layer contains the indicator material, and a second damaged condition in which at least one shell layer is ruptured, releasing indicator material, the polymer composite material being moved from the first condition to the second condition by the application of a predetermined force to the polymer composite material, the release of the indicator material being arranged to indicate to a user that a predetermined force has been applied to the polymer composite material.

According to a third aspect of the present invention, there is provided a method of forming a polymer composite material, the material including a settable matrix material and a plurality of fibre members, the method including incorporating a plurality of capsule members within the polymer composite material, each capsule member including a shell layer encapsulating an indicator material, the polymer composite material being arrangeable in a first initial condition in which each shell layer contains the indicator material, and a second damaged condition in which at least one shell layer is ruptured, releasing indicator material, the polymer composite material being moved from the first condition to the second condition by the application of a predetermined force to the polymer composite material, the release of the indicator material being arranged to indicate to a user that a predetermined force has been applied to the polymer composite material.

According to a fourth aspect of the present invention, there is provided a method of detecting whether a predetermined force has been applied to a material, the method including the step of providing a polymer composite material including a settable matrix material, a plurality of reinforcement members and a plurality of capsule members, each capsule member including a shell layer surrounding an indicator material, the polymer composite material being arrangeable in a first, initial condition in which each shell layer contains the indicator material, and a second damaged condition in which at least one shell layer is ruptured, releasing indicator material, the polymer composite material being moved from the first condition to the second condition by the application of a predetermined force to the polymer composite material, the release of the indicator material being arranged to indicate to a user that a predetermined force has been applied to the polymer composite material, the method including the step of visually inspecting the material in the second condition.

The polymer composite material may be as described in any of the preceding statements.

Embodiments of the present invention will now be described by way of example only and with reference to the accompanying drawings, in which:—

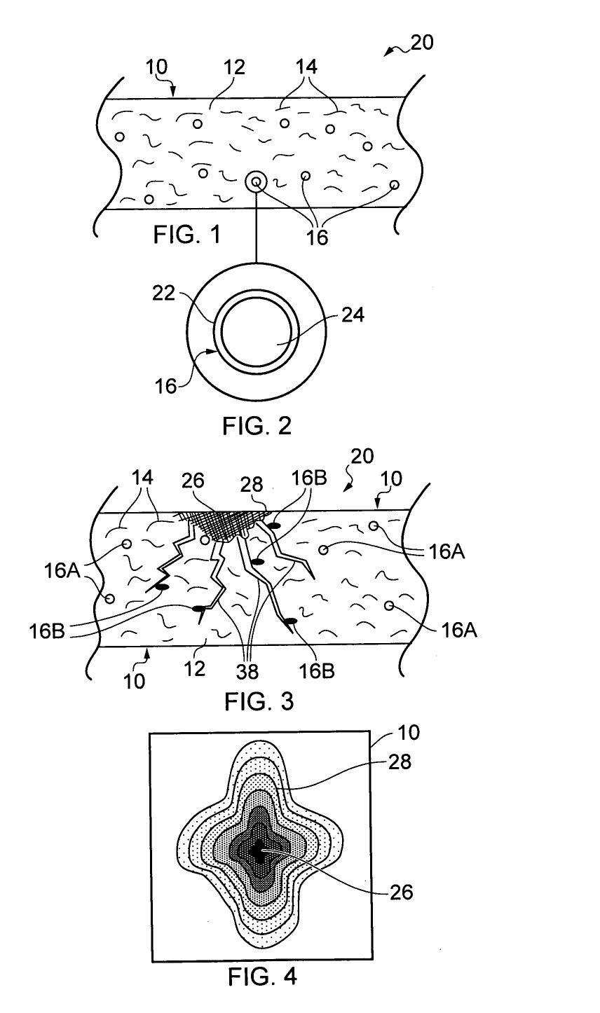

FIG. 1 is a side sectional view of part of a polymer composite material in a first, initial condition;

FIG. 2 is an enlarged detailed sectional view of a capsule member of the polymer composite material of FIG. 1;

FIG. 3 is a side sectional view of the polymer composite material of FIG. 1 in a second, damaged condition;

FIG. 4 is a plan view from above of the polymer composite material of FIG. 3;

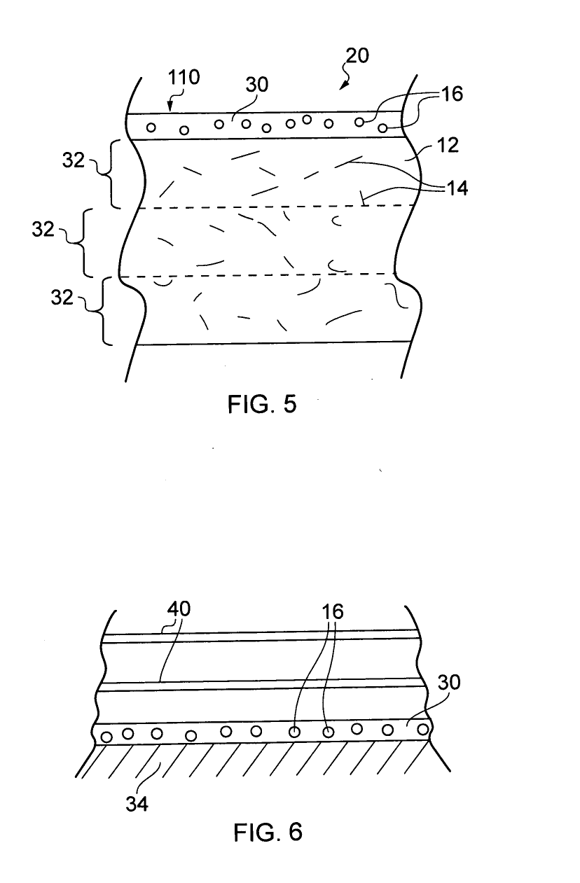

FIG. 5 is a side sectional view of another polymer composite material;

FIG. 6 is a side sectional schematic view of the polymer composite material of FIG. 5 during manufacture;

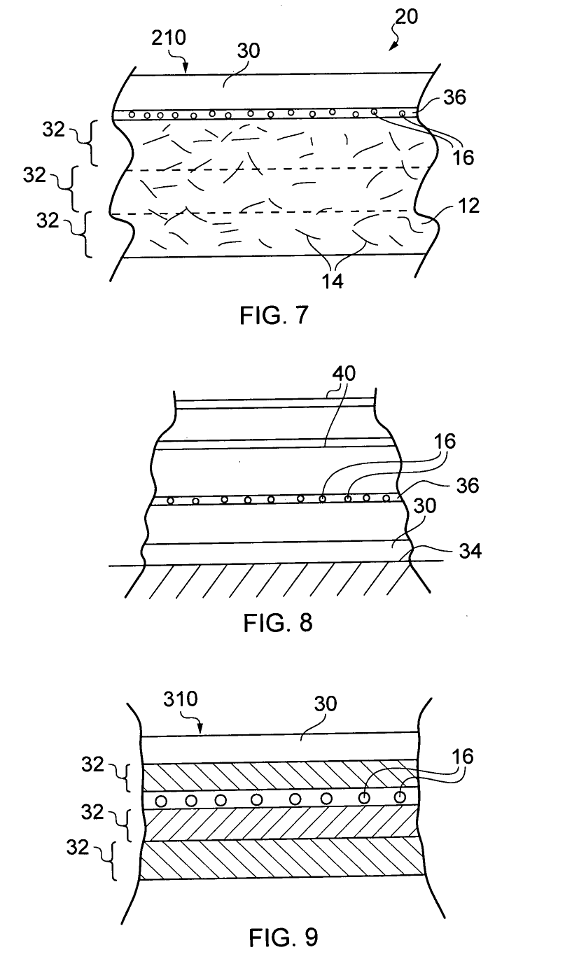

FIG. 7 is a side sectional view of another polymer composite material;

FIG. 8 is a side sectional schematic view of the polymer composite material of FIG. 7 during manufacture; and

FIG. 9 is a side sectional view of yet another polymer composite material

Referring to FIGS. 1 and 2, an product 20 is formed of a polymer composite material 10, which includes a settable matrix material 12, a plurality of reinforcement members 14 (only a few of which are labelled) and a plurality of capsule members 16 (only a few of which are labelled). The matrix material 12 could be a polymer material, and could be a thermoplastic or thermoset polymer. The polymer material could be a resin material, and could be a polyester resin, a vinylester resin, a bismaleimide resin, a polyimide resin, a cyanate ester, an epoxy resin, a phenolic resin or a polyurethane resin. The reinforcement members 14 could be in the form of fibres, and could be formed of glass, carbon, aramid, basalt, boron or combinations thereof. The reinforcement members could be relatively short, or could be relatively long, and could be termed as “continuous” as will be understood by a person skilled in the technical field.

FIG. 2 shows a capsule member 16, which includes a shell layer 22 and a core formed of an indicator material 24, the shell layer 22 encapsulating the indicator material 24 in a first, initial condition. The term “encapsulating” is used to mean that the indicator material is completely enclosed and contained by the shell layer 22. The shell layer 22 could be formed of one or more materials selected from the group consisting of aminoplast, gelatine, gum arabic, urea formaldehyde, melamine formaldehyde, protein, amine, alcohol, polyester, polyurea and polyurethane. The shell layer 22 could be formed, for example, through interfacial polymerisation of a plurality of reactants in a polycondensation, and could be formed through core-shell encapsulation, microgranulation or spray drying.

The capsule member 16 could be a micro capsule, and could have a maximum dimension of 1 mm or less, and optimally could have a maximum dimension of 300 microns or less. Optimally, the micro capsule is substantially spherical in shape, and has an average diameter in the range of 2 to 200 microns. The micro capsules are preferably dry and free flowing.

In one example, the indicator material is a dye. The indicator material could include a carrier material, which could be a material selected from the group consisting of organic solvent, limonene, aromatic hydrocarbon, alcohol, naphthalene, orange oil penetrant, mineral oil and an ester. The ester could be dibutyl phthalate and/or dibutyl sebacate.

FIG. 3 shows the polymer composite material 10 in a second, damaged condition. To reach this condition, a force has been applied to the polymer composite material 10 in the form of an impact at an impact site 26, which has caused damage to the polymer composite material 10. At the impact site 26, the surface of the polymer composite material 10 may appear to be undamaged when inspected visually. However, the impact has caused, for example, a plurality of cracks 38 to form, weakening the material 10, and which may propagate further during subsequent use. The impact force and the cracks 38 have ruptured the shell layers 22 of a number of the capsule members 16, releasing the indicator material 24, which then permeates through the polymer composite material 10. The dye of the indicator material 24 is coloured so that when released from the capsule members 16, the dye is or becomes visible against the colour of the other components of the polymer composite material 10, the dye forming a stain or bruise 28, which surrounds and spreads out from the impact site 26. In FIG. 3, a number of undamaged capsule members 16A are indicated, along with a number of damaged capsule members 16B, which may, for example, have been damaged by the cracks 38. The indicator material 24 could spread along the cracks 38.

As shown in FIG. 4, the intensity of colour of the bruise 28 and the concentration of dye is greatest at the impact site 26, and reduces in concentration and colour intensity moving away from the impact site 26. The stain or bruise 28 is larger than the impact site 26, so that the fact of the occurrence of the damage at the impact site is more apparent to a user. In many circumstances, although the polymer composite material 10 has sustained an impact, there may be no apparent visible damage to the surface of the polymer composite material 10, but a bruise or stain 28 may be formed if the impact has caused rupturing of one or more capsule members 16. Thus, the polymer composite material of the invention provides a visual indication when damage is sustained.

The carrier material is chosen to be a relatively low viscosity material with a relatively low surface tension, so that when the dye 24 is released from the capsule member 16, the dye is carried or permeates easily through the polymer composite material 10.

As the size and colour intensity of the bruise or stain 28 is related to the applied force of the impact, the degree of severity of the damage is immediately apparent even to a relatively unskilled viewer, and by modelling the area and colour intensity of the bruise or stain 28, guidelines with regard to the levels of damage could be derived for use in monitoring damage to components formed of polymer composite material. The guidelines could then be consulted by relatively unskilled operators as a initial guide in determining the action to be taken. Thus, the polymer composite material of the invention permits damage or deterioration in the polymer composite material 10 to be relatively easily identified and quantified, permitting a course of action to be determined, which could include further detailed inspection, monitoring, repair or replacement.

The amount of force required to produce a bruise will depend on a number of factors. The concentration (number per unit volume) of capsule members 16 could be adjusted to increase or decrease the sensitivity of the material to indicating damage. The selection of material of the shell layer 22 and the thickness of the material of the shell layer 22 could be adjusted to alter the sensitivity of indication to a force. The mobility or permeability of the indicator material relative to the other components of the polymer composite material will also affect the size and speed of the bruise formation. The selection of these parameters has to take into account those forces applied during normal operation which do not result in damage, and should not therefore result in a stain or bruise being formed. Thus the polymer composite material is arranged to indicate the application only of a predetermined force, which is likely to cause damage.

Forces other than impact forces could cause damage to the polymer composite material, such as compressive, pressure, abrasion, torsion, tensile and shearing forces, and forces due to temperature, expansion and contraction. As the capsule members are bound within the polymer composite material, any damage sustained by the polymer composite material by any applied force could rupture capsule members and result in bruise formation. Thus, the polymer composite material of the invention permits damage or deterioration in the polymer composite material 10 resulting from the application of any force to be relatively easily identified and quantified.

The colour of the dye material is arranged to be visible against the colour of other components of the polymer composite material. For example red and blue dyes have been found to provide good visual indication against light coloured polymer composite material. In another example, the dye could become visible only under ultraviolet light.

In this embodiment, if both the matrix material 12 and the shell layer 22 permit light transmission, the colour of the dye could be visible as small spots in the initial condition, which could affect the overall appearance of the polymer composite material 10. Thus, in this embodiment, to prevent a possible colour cast in the initial condition, either the matrix material 12 and/or the shell layer 22 could be selected to be opaque.

In another embodiment, the indicator material 24 includes a colour former, which could be one or more materials selected from the group consisting of an aminofluoran, a pyridylazonapthol, a diaminofluoran, a bisaryl carbazolylmethane, a bisindoly phthalide. In the initial condition, the colour former is clear, transparent or translucent or is of a similar colour to the other components of the polymer composite material 10. The polymer composite material 10 includes a reagent in the form of a colour developer which is a material selected from the group consisting of zinc salicylate, zinc neodecanoate, clay, phenolic resin. In the second condition, when the indicator material 24 including the colour former is released from one or more of the capsule members 16, the colour former reacts with the reagent to form a reaction product which is of a different colour and becomes visible against the colour of the other components of the polymer composite material 10. In another example, the reaction product becomes visible, or becomes more visible under ultraviolet light.

In this embodiment, the indicator material 24 is clear, transparent or translucent or is a similar colour to the other components of the polymer composite material 10 in the initial condition, and therefore both of the shell layer 22 and the matrix material 12 can be selected to permit light transmission without the possible problem of a colour cast in the initial condition.

FIG. 5 shows another example of a polymer composite material 110, many features of which are similar to those previously described. Only those features which are different will be described for the sake of brevity, and the same reference numerals have been used for those features which are the same as or similar to those previously described.

The polymer composite material 110 includes a matrix material 12, reinforcement members 14 and a gelcoat layer 30, which forms a surface layer.

The gelcoat layer 30 includes a plurality of capsule members 16, the capsule members 16 including an indicator material 24, which, as for the embodiment shown in FIGS. 1 to 4 could include a dye, or alternatively could include a colour former. In the case in which the indicator material 24 includes a colour former, the gelcoat layer 30 of the polymer composite material 110 includes a reagent. The matrix material 12 could be formed of a plurality of reinforcement layers 32. Each of the reinforcement layers 32 could include a plurality of the reinforcement members 14, which could be in the form of a mat, ply, fabric, roving or any other suitable structure.

FIG. 6 shows in schematic form the formation or manufacturing process of the polymer composite material 110. The gelcoat layer 30 including the capsule members 16 is firstly applied to a mould part 34. A plurality of reinforcement mats 40 are then laid up in sequence against the gelcoat layer 30. As each reinforcement mat 40 is laid up, matrix material 12 is applied into and over each of the reinforcement mats 40. In another example, each of the reinforcement mats 40 could include impregnated matrix material 12 (known as “prepreg”).

In use, a predetermined force, which could for example be an impact force, applied to the gelcoat layer 30, will rupture one or more of the capsule members 16, releasing the indicator material 24 so that a bruise or stain 28 is formed in the gelcoat layer 30. In the case in which the indicator material 24 is a dye, the dye is arranged to be coloured to be visible or to become visible or to become more visible against the colour of the gelcoat layer 30. In the case in which the indicator material 24 includes a colour former which reacts with the reagent, the reaction product formed is arranged to be of colour which is visible or can become visible against the colour of the gelcoat 30.

In another example, capsule members 16 could be provided in the matrix material 12 as well as in the gelcoat 30. The concentration (number per unit volume) of capsule members 16 is optimally greater in the gelcoat layer 30 than in the matrix material 12. Since generally, the gelcoat layer is formed in a separate process step, and is the surface most likely to encounter a damaging force, it can be sufficient to provide capsule members 16 only in the gelcoat layer 30. The provision of the capsule members 16 only within the gelcoat layer 30 is also more economic.

FIGS. 7 and 8 show another polymer composite material 210, many features of which are similar to those described in relation to the previous embodiments. Where features are the same or similar, the same reference numerals have been used, and only those features which are different will be described here for the sake of brevity.

The polymer composite material 210 includes a gelcoat layer 30, a matrix material 12, a plurality of reinforcement members 14 arranged in reinforcement layers 32, and a structure in the form of a veil 36 which is located between the gelcoat layer 30 and the matrix material 12. The veil 36 is relatively finely textured, and is arranged to substantially prevent the pattern of the reinforcement layers 32 showing through the gelcoat 30. The veil 36 could be a nonwoven structure, and could be formed of polyester. In the examples shown in FIGS. 7 and 8, the capsule members 16 are applied to or are carried by the veil 36.

FIG. 8 shows schematically the process of forming the polymer composite material 210. The gelcoat layer 30 is applied to a mould part 34, and the veil 36 carrying the capsule members 16 is then applied to the gelcoat layer 30 and impregnated with the matrix material 12. Reinforcement mats 40 are then located onto the veil 36 and impregnated with matrix material 12, or are provided pre impregnated.

In another example (not shown), a polymer composite material similar to that shown in FIGS. 7 and 8 could be formed, but without the gelcoat layer 30, so that the veil 36 is located at or close to the surface of the product 20.

In the same manner as for previous embodiments, a predetermined force, for example in the form of an impact, applied on the gelcoat 30 or directly to the polymer composite material 10 will cause one or more capsule members 16 to rupture, releasing the indicator material 24, which will then cause a bruise or stain 28 to form.

The polymer composite material 210 could include a plurality of veils 36. Each of the veils 36 could include an increasing concentration of capsule members 16, so that, for example, an impact of greater force will result in a bruise or stain 28 of greater intensity. In another example, different veils 36 could carry capsule members 16 having different colour indicator materials 24, so that an impact of greater force gives a different colour bruise or stain 28, or results in a distinctive colour pattern.

FIG. 9 shows another example in which a polymer composite material 310 is formed which is similar to that shown in FIGS. 7 and 8, but with the veil 36 located between the reinforcement layers 32.

In any of the embodiments shown in FIGS. 1 to 9, the dye or colour former and reagent could be arranged to only be visible under ultraviolet light. This would provide the advantage that damage is not apparent to, for example a member of the public, but becomes visible to an engineer with an ultraviolet light source.

In the case of those embodiments in which the indicator material includes a dye, it is advantageous if the shell material 22 and/or the gelcoat 30 is opaque, so that the colour of the dye is not visible in the initial condition. In the case in which the indicator material 24 is a colour former which reacts with the reagent, the shell material 22 and/or gelcoat 30 can permit transmission of light.

The veil 36 or veils 36 could be positioned anywhere in the matrix material 12 and behind the optional gelcoat 30.

Of the carrier materials, dibutyl phthalate and/or dibutyl sebacate provide enhanced dye permeation, and it is believed this is because these materials have solubility parameters close to that of styrene, both of these materials being esters.

The capsule members 16 could be added in a proportion from 0.05% to 20% w/w to the gelcoat. The proportion of capsule members 16 added depends at least to some extent on the relative colouration of the gelcoat 30 or matrix material 12 and the indicator material 24, with, in general, darker coloured gelcoats requiring higher concentrations of capsule members 16. In one example, a proportion of capsule members 16 of approximately 1.7% w/w was used with a white gelcoat. In another example, a proportion of capsule members 16 of approximately 9% w/w was used with a grey gelcoat.

As the proportion of micro capsules increases, the bruising or staining effect is improved, but cost is increased and also the greater concentration of capsule members 16 may affect the overall colour of the polymer composite material.

Various other modifications could be made without departing from the scope of the invention. The capsule members could be of any suitable size and shape, and could be formed of any suitable material. The indicator material could be of any suitable material. The polymer composite material could be formed of any suitable material. The micro capsules could be located within the polymer composite material in any suitable location. The polymer composite material could be formed by any suitable process. The dye and/or colour former and reagent could produce any suitable colour. The gelcoat layer and the reinforcement layer or layers could be of any suitable thickness.

The invention could include any suitable combination of any of the features disclosed in any of the embodiments.

There is thus provided a polymer composite material which provides a number of advantages. When subjected to a predetermined force, damage to the composite material is indicated by the formation of a bruise or stain, so that the damage is apparent to a relatively unskilled user either in ordinary light, or under ultraviolet light. The indicator material is integral with the polymer composite material, so that the polymer composite material becomes effectively “self monitoring” and “self indicating”, without requiring any additional materials or equipment. The integral indicator material is always present, for the life of the polymer composite material, and cannot be lost, misused or misapplied. The integral indicator material cannot be degraded or worn away in use without becoming visible. The bruise or stain can become visible to ordinary users rather than only to specialist inspection personnel, so that damage can be identified and located at an earlier stage and during normal use, rather than only at inspection or maintenance intervals, or after a failure or other problem has occurred. Inspection and testing methods can be simplified, and initial inspection can be undertaken by relatively unskilled operators. The size and colour intensity of the bruise provides an indication of the severity of the damage sustained.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A polymer composite material, the material including a settable matrix material, a plurality of reinforcement members, a veil, and a plurality of capsule members, the capsule members being applied to or carried by the veil, each capsule member including a shell layer encapsulating an indicator material, the polymer composite material having an initial condition in which each shell layer contains the indicator material, and a damaged condition in which at least one shell layer is ruptured, releasing indicator material, the polymer composite material being changed from the initial condition to the damaged condition by the application of a predetermined force to the polymer composite material.

2. A polymer composite material in accordance with claim 1, wherein the polymer composite material includes a gelcoat layer.

3. A polymer composite material in accordance with claim 2, wherein the gelcoat layer forms a surface layer over the matrix material.

4-7. (canceled)

8. A polymer composite material in accordance with claim 1, wherein the matrix material is one of a thermoplastic polymer and a thermoset polymer.

9. A polymer composite material in accordance with claim 8, wherein the polymer material comprises at least one of a resin material, a polyester resin, a vinylester resin, a bismaleimide resin, a polyimide resin, a cyanate ester, an epoxy resin, a phenolic resin and a polyurethane resin.

10-13. (canceled)

14. A polymer composite material in accordance with claim 1, wherein each capsule member is a microcapsule, having a maximum dimension of 1 mm or less.

15. A polymer composite material in accordance with claim 14, wherein each microcapsule has a maximum dimension of 300 microns or less.

16. A polymer composite material in accordance with claim 1, wherein the shell layer is formed of at least one material selected from the group consisting of: gelatine, gum arabic, aminoplast, urea formaldehyde, melamine formaldehyde, protein, amine, alcohol, polyester, polyurea and polyurethane.

17. A polymer composite material in accordance with claim 1, wherein the shell layer is formed through one of: interfacial polymerisation of a plurality of reactants in a polycondensation, core-shell encapsulation, microgranulation and spray drying.

18. A polymer composite material in accordance with claim 1, wherein the shell layer is substantially opaque.

19-22. (canceled)

23. A polymer composite material in accordance with claim 1, wherein the indicator material is a dye, coloured to be visible or become visible in the second condition against the colour of other components of the polymer composite material.

24. A polymer composite material in accordance with claim 23, wherein the dye becomes visible or more visible in ultraviolet light.

25-27. (canceled)

28. A polymer composite material in accordance with claim 1, wherein the indicator material includes a colour former.

29. A polymer composite material in accordance with claim 28, wherein the colour former includes at least one material selected from the group consisting of an aminofluoran, a pyridylazonapthol, a diaminofluoran, a bisaryl carbazolylmethane, and a bisindoly phthalide.

30. A polymer composite material in accordance with claim 28, wherein the polymer composite material includes a reagent, which in the second condition reacts with the colour former to form a reaction product which is visible (either visible or ultraviolet spectra) or can become visible against the colour of other components of the polymer composite material.

31. A polymer composite material in accordance with claim 30, wherein the reagent is a material selected from the group consisting of zinc salicylate, zinc neodecanonate, clay, phenolic resin.

32. (canceled)

33. A method of forming a polymer composite material, the method including incorporating a plurality of capsule members and a veil within the polymer composite material, each capsule member being applied to or carried by the veil, and comprising a shell layer encapsulating an indicator material and arranged to release the indicator material when a predetermined force is applied to the polymer composite material.

34. A method of detecting whether a predetermined force has been applied to a polymer composite material in accordance with claim 1, the method including the step of visually inspecting the material.

35. (canceled)

36. A polymer composite material in accordance with claim 2, wherein the veil is arranged to substantially prevent patterns therebehind showing through the gelcoat layer.

37. A polymer composite material in accordance with claim 1, wherein the veil is a non-woven structure.
